(19) United States
(12) Patent Application Publication
(10) Pub. No.: US 2008/0165087 A1
(43) Pub. Date: Jul. 10, 2008

(54) PLASMA DISPLAY PANEL DRIVING METHOD AND PLASMA DISPLAY DEVICE

(76) Inventors: Ryo Nakano, Yokohama (JP); Masaya Tajima, Higashimurayama (JP); Yasuji Noguchi, Yokohama (JP)

Correspondence Address: MILES & STOCKBRIDGE PC, 1751 PINNACLE DRIVE, SUITE 500, MCLEAN, VA, 22102-3833, US

(21) Appl. No.: 11/847,137

(22) Filed: Aug. 29, 2007

(30) Foreign Application Priority Data
Jan. 9, 2007 (JP) JP2007-001685

(51) Int. Cl. G09G 3/28

(52) U.S. Cl. 345/60

(57) ABSTRACT

The present invention relates to a PDP device, and mainly provides a technique for preventing occurrence of flicker (in particular, line flicker in an interlace display). In the present PDP device, by control operation in a control circuit, in each of odd numbered and even numbered fields of the conventional art, both odd numbered and even numbered display line groups are continuously driven in a first half and a second half based on the same data (data of the odd numbered display line) as a new field structure.

### CROSS-REFERENCE TO RELATED APPLICATION

The present application claims priority from Japanese Patent Application No. JP 2007-001685 filed on Jan. 9, 2007, the content of which is hereby incorporated by reference into this application.

### TECHNICAL FIELD OF THE INVENTION

The present invention relates to a plasma display panel (PDP) driving method and a plasma display device (PDP device) provided with the PDP, in particular, to an interlace drive-display of a display line group of a field.

### BACKGROUND OF THE INVENTION

In the PDP driving display, a method of drive-displaying all the display line groups of the PDP display region in order in one field (progressive method), and a method of drive-displaying one of odd numbered or even numbered display line group of the PDP display region in one field (interlace method) are used. In the interlace method, for example, the odd numbered display line group is drive-displayed in an odd numbered field, the even numbered display line group is drive-displayed in a subsequent even numbered field, and an image frame is displayed by combining the odd numbered and even numbered fields. In the PDP device of a so-called ALIS method, the interlace method is used.

As a technical challenge of the PDP device, countermeasures for flicker exist. Generally, as a display period of a field and the like becomes longer, in other words, as a display frequency becomes lower, the flicker becomes visible higher. In particular, in display of the interlace method, occurrence of line flicker is a problem.

As a method of preventing occurrence of the flicker in a conventional PDP device, for example, as shown in Japanese Patent Application Laid-Open Publication No. 2000-112431 (Patent Document 1), a method in which the display periods (frame periods) of the odd numbered and even numbered display line group in the interlace method are reduced to less than 33 msec (for example about 17 msec, that is, half thereof) with respect to 33 msec (60 Hz at a display frequency) in one frame in the conventional art is proposed (hereinafter, referred to as a first conventional art).

And, in Japanese Patent Application Laid-Open Publication No. 10-274959 (Patent Document 2), in a technique of driving the PDP based on image data of the interlace method including odd numbered and even numbered fields, a technique of preventing occurrence of flicker at an upper end and a lower end by generating write data for three lines based on display data of a horizontal line of an upper end or a lower end is described.

### SUMMARY OF THE INVENTION

In the method of the first conventional art, occurrence of surface flicker can be prevented by reducing the display period (increasing display frequency), however, there is a problem that occurrence of line flicker cannot be prevented completely. For example, in the case where the display frequency is 50 Hz, even if the drive is performed at double speed thereof (100 Hz), flicker at 50 Hz remain in unit of line in the case of the interlace method. The surface flicker means the entire screen flicker generated because an afterimage effect cannot be obtained due to a low frequency (a long period), in display of a field group. And, the line flicker means a flicker of line such as one horizontal line, the horizontal edge and the like having a half period of the display frequency due to the interlace display.

And, in the method of the first conventional art, if the frame period is reduced, there is a problem that a processing speed (for example, a control clock frequency) has to be increased because high speed display data input/output control such as an operation of transferring the display data to the memory in short time is required.

The present invention has been made in view of the foregoing problems, and an object of the present invention is to provide a technique related to the PDP device and can mainly prevent occurrence of flicker (in particular, line flicker in interlace display).

An outline of typical elements of the invention disclosed in this application is described briefly as follows. In order to achieve the above object, the present invention includes a technique of a PDP driving method and a PDP device and has a following structure.

In the present PDP device, the PDP (supporting ALIS structure) is structured such that a plurality of first (X) and second (Y) electrodes to be used in sustain discharge are alternately (repetitively) arranged at a similar interval in a second direction with a structure extending parallel to a first direction over a substrate mainly composed of glass, a plurality of third electrodes (address electrode) to be used in address discharge is arranged with a structure extending parallel to the second direction intersecting with the first direction, a display line (L) is structured of a pair of adjacent first and second electrodes, and a display cell (C) is constructed at an intersection of the display line and the third electrode. And, in a PDP, the odd numbered display line (Lo) group is composed of pairs of a plurality of the first electrodes (X) and the second electrodes (Y) adjacent on one side and an even numbered display line (Le) group is composed of pairs of a plurality of the first electrodes (X) and the second electrodes (Y) adjacent on the other side, respectively. Furthermore, the present PDP device includes a control circuit, drive circuits (an X drive circuit, a Y drive circuit, and an address drive circuit) corresponding to respective electrodes and the like as a circuit section. The control circuit performs a display drive control including specification of data (field, sub-field data and the like) used in the display line group to be an object of drive-display (that is, an object of an address and a sustain discharge operation). And, in the present PDP device, a field (F) associated with the display region and the fixed period by a matrix of the display cell of the PDP is constructed in a structure temporally divided into a plurality of (n) sub-fields (SF1 to SFn) each having an address period and a sustain period for gray-scale expression.

In the present PDP device, following processings are performed in the circuit section. The present PDP device basically employs a method (a first control) of displaying one image frame (f) by two fields (odd numbered field: Fo, even numbered field: Fe) made by dividing the image frame into the odd numbered and even numbered display line (Lo, Le) groups. Furthermore, in the present PDP device, in one field (Fo/Fe) (a first field structure) for displaying one of the odd numbered or even numbered display line groups of the conventional art, a display line set (LP) composed of adjacent odd numbered and even numbered display lines in the odd numbered and even numbered display line groups is defined as a control unit, taking at least one or more (typically, all) display line set (LP) as a subject, control and process of continuously drive-displaying both odd numbered and even numbered display lines (Lo, Le) in a time division manner using only one display data (DLo/DLe) of odd numbered and even numbered display line (Lo/Le) is performed. This control is referred to as a second control in contrast with the first control in a usual (basic) interlace method. By this control, occurrence of flicker, in particular, line flicker in a screen including the display line is prevented or suppressed. Furthermore, in the display data input/output control, since the display line set (LP) is driven by continuously using one display data (DLo/DLe) of the odd numbered and the even numbered display line, the processing speed have margin.

And, in the present PDP device, in above description, one field (Fo/Fe) is divided into a first half (a first half field (F-A)) and a second half (a second half field (F-B)) portions in division of sub-field unit in the continuous drive-display (the second control) of the display line set (LP), and in the first half (F-A) portion, using one data, for example, using the display data (DLo) of the odd numbered display line (Lo), the odd numbered display line (Lo) is drive-displayed, and in the second half portion (F-B), the other even numbered display line (Le) is drive-displayed using the display data (DLo) of the odd numbered display line (Lo), the same way as the first half portion (F-A).

In the present PDP device, in above description, in the drive-display of the continuous odd numbered and even numbered fields (Fo, Fe) in display of the image frame (f) group, drive-displaying is performed using the display data (DLo) of the odd numbered display line (Lo) in the continuous drive-display (the second control) of the display line set (LP) in the odd numbered field (Fo), and drive-displaying is performed using the display data (DLo) of the odd numbered display line (Lo) which is the same as that used for the odd numbered field (Fo) one before in the continuous drive-display (the second control) of the display line set (LP) in the following even numbered field (Fe) to drive-display the display line set (LP) simultaneously.

The effects obtained from typical elements of the invention disclosed in this application are described briefly as follows. The present invention relates to the PDP device, and mainly, occurrence of flicker (in particular, line flicker in the interlace display) can be prevented by the invention. Furthermore, the processing speed has margin because of avoidance of requirement for the processing speed to be increased more than that in the conventional art and the like.

### BRIEF DESCRIPTIONS OF THE DRAWINGS

FIG. 1 is a diagram showing a block structure of a whole PDP device according to respective embodiments of the present invention;

FIG. 2 is a diagram showing a constructional example of a PDP in the PDP device according to respective embodiments of the present invention;

FIG. 3 is a diagram showing a structure of a drive sequence of an image frame of a PDP device according to a first embodiment of the present invention;

FIG. 4A is a diagram schematically showing a usage relationship of display data in display of field and the like in the PDP device according to the first embodiment of the present invention;

FIG. 4B is a diagram schematically showing the usage relationship of display data in display of field and the like in the PDP device according to the first embodiment of the present invention;

FIG. 5A is a diagram showing a structure of a drive sequence of an image frame in a first constructional example in a PDP device of a second embodiment of the present invention;

FIG. 5B is a diagram showing the structure of the drive sequence of the image frame in the first constructional example in the PDP device of the second embodiment of the present invention;

FIG. 6A is a diagram showing a structure of a drive sequence of an image frame in a second constructional example in the PDP device of the second embodiment of the present invention;

FIG. 6B is a diagram showing the structure of the drive sequence of the image frame in the second constructional example in the PDP device of the second embodiment of the present invention;

FIG. 7 is a diagram showing a constructional example of a drive sequence of an image frame in a PDP device of a third embodiment of the present invention;

FIG. 8 is a diagram showing a constructional example of a drive sequence of an image frame in a PDP device of a fourth embodiment of the present invention;

FIG. 9 is a diagram showing a constructional example of a drive sequence of an image frame in a first constructional example in a PDP device according to a fifth embodiment of the present invention;

FIG. 10A is a diagram showing an example of a region of a screen of a PDP in a second constructional example in the PDP device according to the fifth embodiment of the present invention;

FIG. 10B is a diagram showing the example of the region of the screen of the PDP in the second constructional example in the PDP device according to the fifth embodiment of the present invention; and

FIG. 10C is a diagram showing the example of the region of the screen of the PDP in the second constructional example in the PDP device according to the fifth embodiment of the present invention.

### DESCRIPTIONS OF THE PREFERRED EMBODIMENTS

The embodiments of the present invention will be described in detail below based on the drawings. In all of the drawings for explaining the embodiments, the same members are denoted by the same reference symbols in principle and repetitive descriptions thereof will be omitted.

### First Embodiment

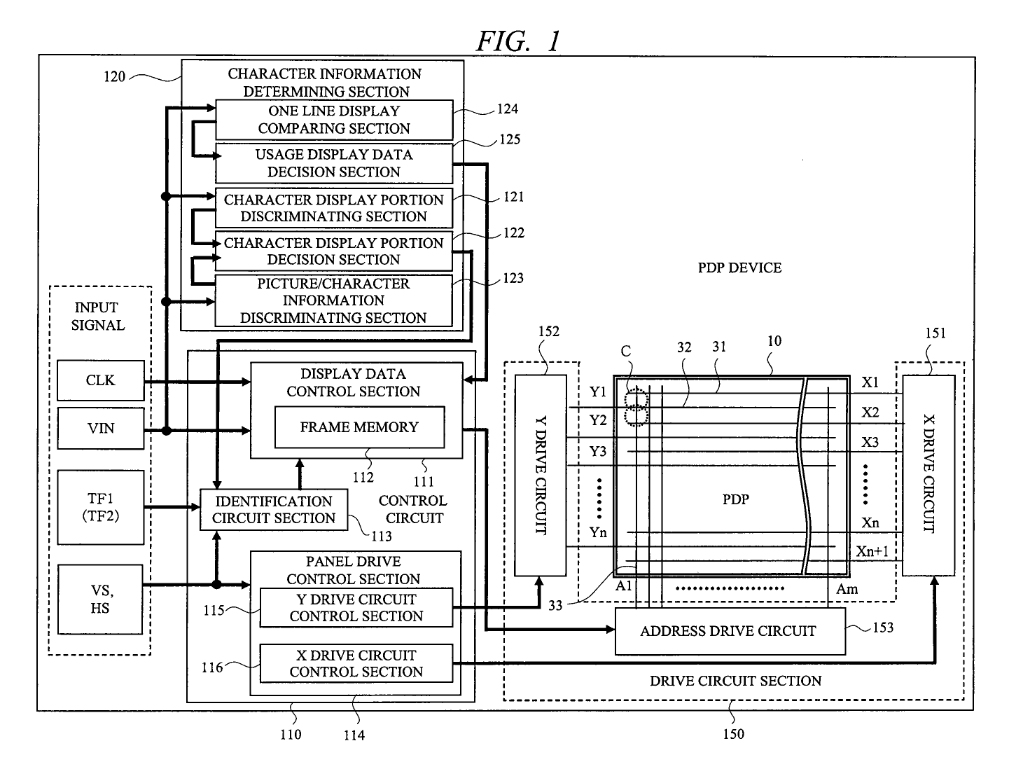

A PDP device of a first embodiment of the present invention will be described using FIGS. 1 to 4A and 4B. The first embodiment has a feature that, in respective odd numbered and even numbered fields of conventional art, by newly driving both odd numbered and even numbered display line groups continuously in a time division manner based on the same data (data of odd numbered display lines), flicker is prevented.

### <PDP Device>

A block structure of the PDP device according to the first embodiment will be described with reference to FIG. 1. The PDP device includes a control circuit 110, a drive circuit section 150, a PDP 10, a character information determining section 120 and the like. The control circuit 110 includes a display data control section 111 including a frame memory (field memory) 112, an identification circuit section 113, and a panel drive control section 114 and the like. The control circuit 110 also includes a signal processing circuit, and controls the whole PDP device including the drive circuit section 150. The PDP 10 is a panel in which a display region is composed of a matrix of display cells (cell: C) associated with pixels, for example, three electrodes AC drive (AC) type panel provided with X electrodes 31, Y electrodes 32, and address (A) electrodes 33. The drive circuit section 150 drives respective electrode groups (31, 32, 33) of the PDP 10 through voltage application by respective corresponding drive circuits (an X drive circuit 151, a Y drive circuit 152, an address drive circuit 153). And therefore, a picture is displayed on the display region of the PDP 10.

The input signals of the PDP device are a control clock CLK, display data (picture/image signal) VIN, a vertical synchronous signal VS, a horizontal synchronous signal HS, and the like.

Synchronous signals such as CLK, HS, and VS and the like are inputted into the control circuit 110, and the control circuit 110 generates and outputs a timing signal necessary for controlling each section. In the display data control section 111, signal processing (gray-scaling processing) including SF conversion process and the like are performed based on the input display data VIN, and the drive circuit section 150 is drive-controlled to generate output display data (field and SF data and drive control signal) for displaying moving image of gray-scale on the PDP 10. In the display data control section 111, the input display data VIN, data obtained by signal processing the display data VIN, and output display data are inputted to and outputted from the frame memory 112. The drive circuit section 150 generates and outputs a drive sequence including a voltage waveform for driving the electrode groups of the PDP 10 according to the display data (drive control signal) from the control circuit 110. The output display data is stored in the frame memory 112 by field unit. The SF data of one field is sequentially outputted from the frame memory 112 to the drive circuit section 150 at timing of every one field display.

The panel drive control section 114 includes a Y drive circuit control section 115 controlling the Y drive circuit 152 and an X drive circuit control section 116 controlling the X drive circuit 151. And, the address drive circuit 153 is controlled from the display data control section 111. The X drive circuit 151 commonly drives the X electrode 31 group (X1 to Xn+1) for sustain discharging operation. The Y drive circuit 152 includes a scanning drive circuit, commonly drives the Y electrode 32 group for sustain discharging operation and individually drives the Y electrode 32 group for scanning operation. The address drive circuit 153 individually drives the address electrode 33 group for address operation.

A first field discrimination signal TF1 or a second field discrimination signal TF2, VS, HS, and the like are inputted into the identification circuit section 113, and the identification circuit section 113 identifies timing of a field and a display line for display control. Information of identification result is outputted from the identification circuit section 113 to the display data control section 111 and the like.

### <PDP>

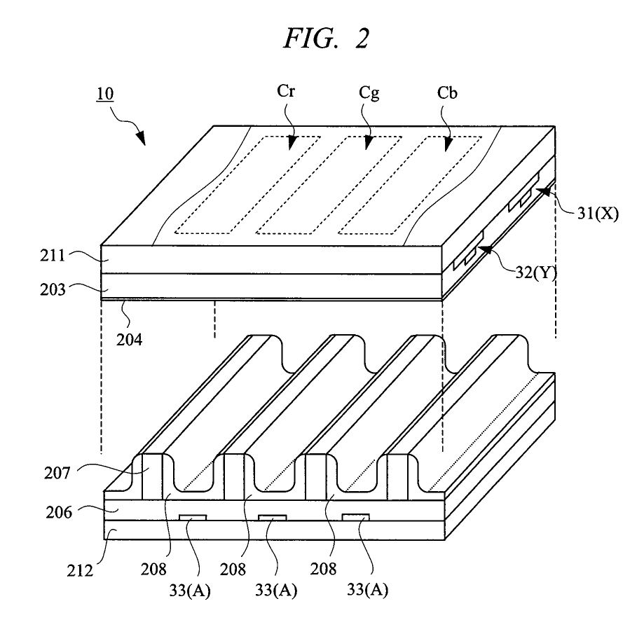

In FIG. 2, a panel constructional example (in the case of three electrodes, ribs of stripe form) of the PDP 10 will be described. One part corresponding to pixels (set of cells (Cr, Cg, Cb) of each color) in the PDP 10 is shown. The PDP 10 is constructed by combining structural bodies of a front face substrate 211 and a rear face substrate 212 composed mainly of glass so as to face each other, sealing a peripheral part thereof, and enclosing discharge gas in space therebetween.

A plurality of X electrodes 31 and Y electrodes 32, which are display electrodes by sustain discharge are extended in parallel in a first direction (row or horizontal line direction) and alternately formed in a second direction (column or vertical line direction) over the front face substrate 211. The display electrode groups are covered by a dielectric layer 203, and a surface of the dielectric layer 203 is covered by a protective layer 204. A plurality of address electrodes 33 are formed extending in parallel in the second direction over the rear surface substrate 212, and covered by a dielectric layer 206. Dividing walls (ribs) 207 of stripe form extending in the second direction are formed over the dielectric layer 206 and on both sides of the address electrode 33 to divide the column. Furthermore, phosphors 208 emitting visible light of each color of red (R), green (G), and blue (B) when excited by ultraviolet are applied between the dividing walls 207 over the dielectric layer 206.

The rows (lines) of the display are constructed in correspondence with a pair of display electrodes (31, 32), and the column of the display and cell (C) are constructed in correspondence with an intersection with the address electrode 33. The display region of the PDP is constructed by the cell (C) matrix, and is associated with the field and the SF, which is to be a display unit. The PDP takes various structures depending on a driving method and the like.

### <Field>

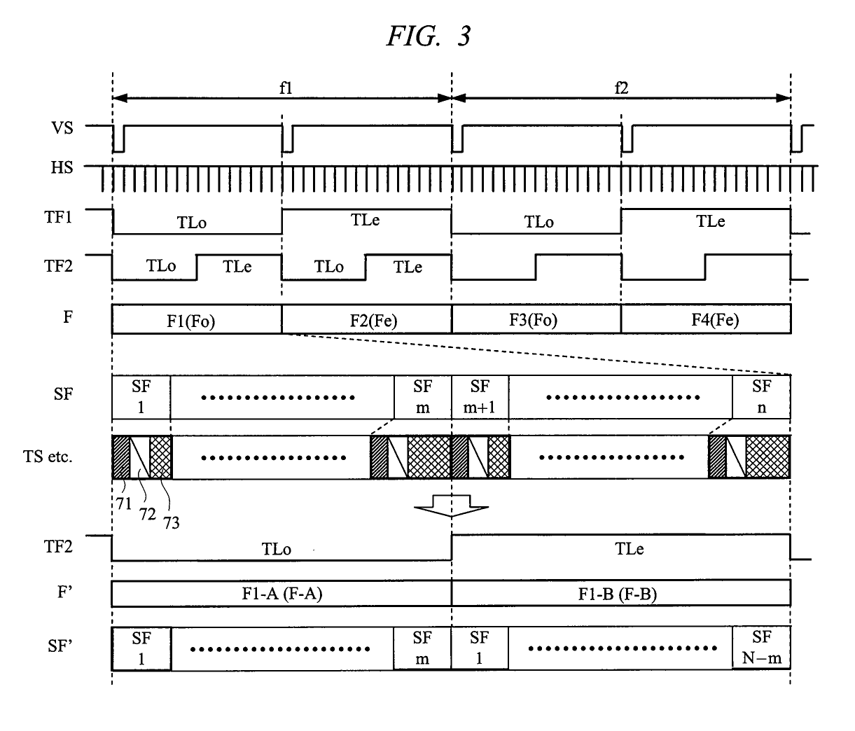

Next, a structure of a basic field (field period), an SF (SF period) and the like in the drive control (the first control) of the interlace method of the PDP 10 will be described (see FIG. 3). One image frame (f) is associated with two fields (F) obtained by time-division by an odd numbered display line (Lo) group and an even numbered display line (Le) group, that is, an odd numbered field (Fo) and an even numbered field (Fe). One field (F) is displayed with a display period of 1/60 sec, for example. The field (F) is constructed by a plurality of (n) SF (SF1 to SFn) temporally divided for gray-scale expression. Each SF is structured by a sustain period 73 in which sustain discharge is performed, an address period 72 before the sustain period 73, a reset period 71 and the like. Each SF constituting the field (F) is given luminance weight according to a length of the sustain period 73, that is, number of sustain pulses and the like. The gray-scale is expressed by selection and combination of ON (lighted)/OFF (non-lighted) of each SF in each cell of the field.

In the reset period 71, reset operation adjusting a charge state of the cell group to prepare for the next address period 72 is performed. In the next address period 72, address operation selecting a location of ON/OFF in the cell group of the SF is performed. That is, in the address operation, an address discharge is generated by application of scanning pulse to the Y electrode 32 and application of address pulse to the address electrode 33 in correspondence with the selected cell with respect to the display line group to be driven. In the next sustain period 73, sustain operation causing light emitting display through generation of the sustain discharge in the cell addressed (selected) in the address period 72 immediately before by applying a sustain pulse to the display electrodes (31, 32) group is performed.

### <Drive Sequence (1)>

Next, with reference to FIG. 3, a structure of a characteristic drive control (drive sequence) by process of the control circuit 110 in the present PDP device will be described. Image frames (f) to be displayed, for example, a first frame (f1) and a following second frame (f2) are shown. Display timing of the field (F) is discriminated by VS with respect to the image frame (f). Furthermore, display timing of each display line (L) in the field (F) is discriminated by HS. A first field discriminating signal TF1 discriminates a field structure (referred to as a first field structure) in a basic interlace method (the first control) of the conventional art. A timing (TLo) corresponding to the odd numbered field (Fo) targeting on the odd numbered display line (Lo) group and a timing (TLe) corresponding to the even numbered field (Fe) targeting on the even numbered display line (Le) group are discriminated by TF1. Note that, the odd number and the even number are interchangeable in the structure of FIG. 1 and the like.

And, a second field discriminating signal TF2 is used to discriminate a field structure (second field structure) in the second control specific to the embodiment of the present invention. In the present first embodiment, the field (F) of the first field structure of each of the odd numbered field (Fo) and the even numbered field (Fe) is divided into two partial periods of first half and second half (referred to as a first half field and a second half field in the present example) by the TF2, and the timing (TLo) corresponding to the first half field (F-A) targeting on the odd numbered display line (Lo) group and the timing (TLe) corresponding to the second half field (F-B) targeting on the even numbered display line (Le) group are discriminated. And, in the second field structure (referred to as F′), the odd numbered display line (Lo) is drive-displayed in the first half field (F-A), and subsequently, the even numbered display line (Le) is drive-displayed in the second half field (F-B). In a set (LP) of adjacent odd numbered and even numbered display lines, the display line on one side, that is, the odd numbered display line (Lo) in the present example, is driven using the display data (DLo) of the source (the first control), and the display line on the other side, that is, the even numbered display line (Le) in the present example, is continuously driven using the display data (DLo) which is the same as the other (odd numbered) side.

In the first field structure, n pieces of SF, SF1 to SFn in time order are provided as the SF structure. The n is, for example, 10 or 12. A weighing structure of the SF may take various forms. For example, the structure which is the same for the first half and the second half can be employed. On the other hand, in the second field structure (F′), a field is divided into first half and second half by TF2. For example, F1 (Fo) is divided into F1-A of the first half and F1-B of the second half. The division is performed at a boundary of SF. The first half field (F-A) includes m pieces of SF, that is, SF1 to SFm as the SF structure. The second half field (F-B) includes (n-m) pieces of SF, that is, SFm+1 to SFn as the SF structure. Note that, a relation m<n is satisfied. And, if the SF structure (SF′) of the second field structure (F′) is recast in correspondence with individual structure for the first half and the second half on the basis of the SF structure of the first field structure, the second field (F-B) may be SF1 to SFn-m. And, for example, division is carried out with setting the number of SF of the first half and the second half as the same m (2m=n). The m is, for example, 5 or 6.

In the second control, for example, the display period of the image frame (f) is set to about 33 msec, the display period of the first field structure (F) is set to about 17 msec, a half thereof, and the display period of the second field structure (F′) is set to about 8 msec, a half thereof. And therefore, occurrence of flicker can be prevented.

### <Display Data>

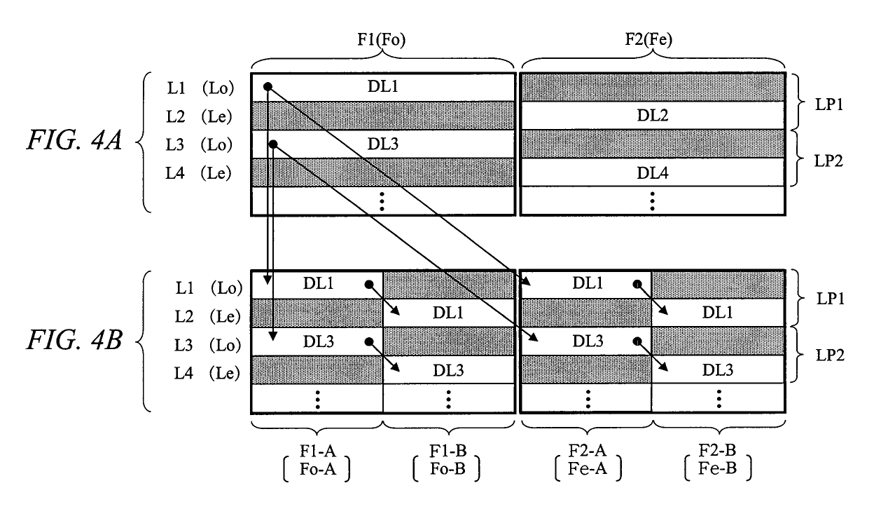

FIGS. 4A and 4B show a relationship of a usage relationship of display data in a field, a display line and the like in the drive control (FIG. 3) of the first embodiment schematically. In FIG. 4A, display data used for driving of display lines (for example, L1 to L4) of part of a region in two odd numbered and even numbered fields Fo, Fe (for example, F1, F2) for structuring one image frame (f) in the usual interlace method (the first control) is shown. The white part is a subject of the drive-display. In F1 (Fo), the odd numbered display line (for example, L1) is driven with the display data thereof (for example, DL1), and in F2 (Fe), the even numbered display line (for example, L2) is driven with the display data thereof (for example, DL2). Here, as a control unit, a set of odd numbered and even numbered display lines is set as LP (for example, LP1, LP2).

Similarly, in FIG. 4B, display data used for driving of display lines corresponding to the second field structure (F′) in the two fields Fo, Fe of the image frame (f) in the second control based on the first control of FIG. 4A is shown. As shown in FIG. 3, each field (Fo, Fe) is constructed by being divided into the first half field (F-A) and the second half field (F-B). For example, F1 (Fo) is constructed by F1(Fo)-A and F1(Fo)-B, and F2(Fe) is constructed by F2(Fe)-A and F2(Fe)-B. In the second control, the odd numbered display line (for example, L1) is driven using the display data thereof (for example, DL1) in Fo-A (for example, F1-A) and subsequently, the adjacent even numbered display line (for example, L2) is driven using the display data (for example, DL1) which is the same as that for the odd numbered display line (for example, L1) in Fe-B (for example, F1-B) in each display line set (LP) of the display region of PDP10. Arrows indicate a usage relationship of the same display data.

In the first control of conventional art, only one of the odd numbered or even numbered display line group is driven in one field (Fo, Fe), but in the present embodiment, both the odd numbered and even numbered display line groups are continuously driven in a time division manner in one field (Fo, Fe). In so doing, the odd numbered and even numbered display lines are driven using the same data. And, in the present embodiment, in two consecutive fields (Fo, Fe), both the odd numbered and even numbered display line groups are continuously driven similarly. In so doing, the both odd numbered and even numbered fields are driven using the same data. For example, in the drive of the first display line set (LP1), the odd numbered field (Fo) and the following even numbered field (Fe) are driven commonly using the display data (DL1) of the first display line (L1). This is the same for the other display line set (LP).

### <Selection of Usage Display Data>

In the present PDP device, the character information determining section 120 further includes a one line display comparing section 124 and a usage display data decision section 125. Thus, which display data, the odd numbered or the even numbered display data in the set of the display line (LP) to use is selected and determined by automatically discriminating which is more appropriate for each field. In terms of display contents, for example, in the case where a display of one line exists in the odd numbered line group, if display is performed using display data of the even numbered line, it means that the display of one line is lost. And therefore, by present function, discrimination of how many displays of one line exists is made in the odd numbered and even numbered display lines respectively, a greater one is selected, and display data to be used for each field is changed. In the one line display comparing section 124, the number of odd numbered and even numbered displays of one line in the odd numbered and the even numbered display line groups are compared. Based on the result, in the usage display data decision section 125, which display data to be used, odd numbered or even numbered, is determined definitely. The information on the selection of which display data to be used is transmitted from the usage display data decision section 125 to the display data control section 111, and in the display data control section 111, a panel drive is performed using the selected display data.

### Second Embodiment

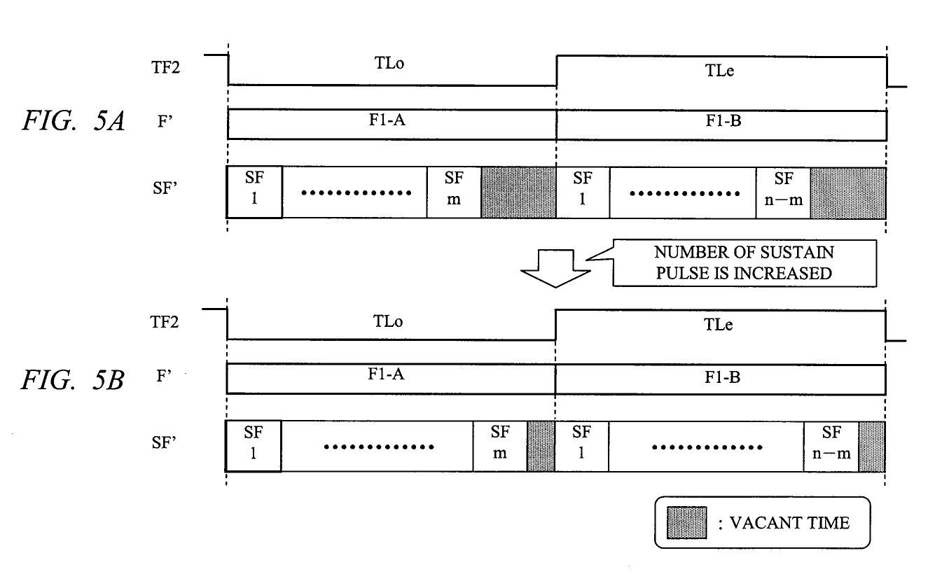

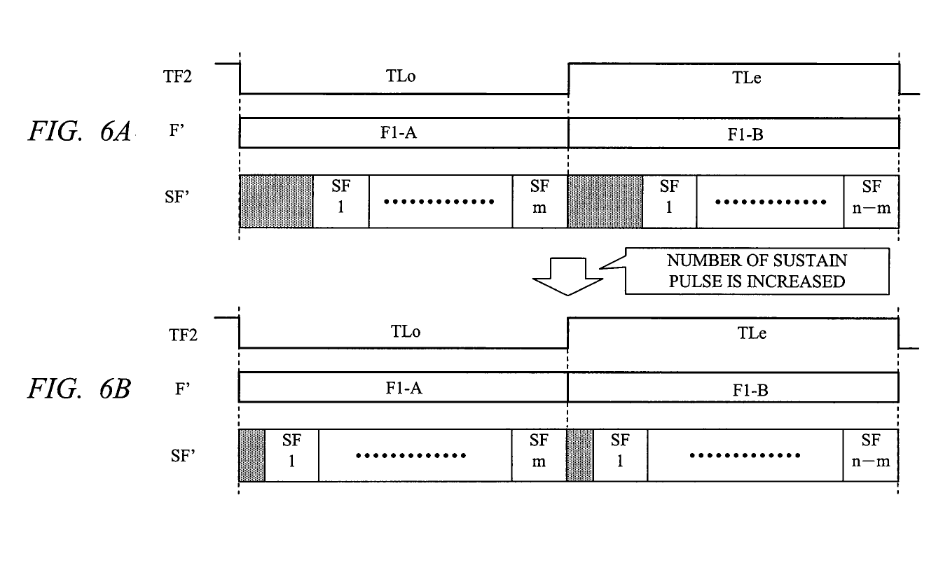

Next, the PDP device of a second embodiment of the present invention will be described with reference to FIGS. 5A to 5B and 6A to 6B. In the second embodiment, a basic structure is similar to that of the first embodiment, and vacant time generated in the field structure is arranged at the end of each period of the first half and the second half of the second field structure (F′).

### <Driving Sequence (2-1)>

A structure (first constructional example) of a drive sequence of the second embodiment will be described with reference to FIGS. 5A and 5B. A timing of the first half field (for example, F1-A) and the second half field (for example, F1-B) in the second field configuration (F′) in the second control are discriminated by the TF2 with respect to each field (Fo, Fe) of the image frame (f). And, with respect to the basic field structure (F, F′) shown in FIG. 3, vacant time (downtime) of drive exists as the SF structure (SF′) in the second field structure (F′) as shown in FIG. 5A. The vacant time is a time that is not SF and in which no processing operation is performed in the field (F) of a fixed time. In the PDP device, such vacant time is generated in the case where a control to increase or decrease a length of the sustain period 73 of SF is performed, such as the known APC (Automatic Power Control) and the like.

FIG. 5B shows a case in which the number of sustain pulse is increased by the APC operation and the sustain period of each SF in the second field structure (F′) is increased with respect to the state of FIG. 5A. Thus, the vacant time are reduced in the first half and the second half fields (F-A, F-B). In the second embodiment, such vacant time is arranged at the end of first half and the second half fields (F-A, F-B) in the second field structure (F′), respectively.

In the APC, luminance and power of the display are increased and decreased in correlation based on display rate and the like of the display data. For example, if the field display rate (ON rate) is low, the number of sustain pulse is increased and the sustain period 73 is increased to increase the luminance of the display, on the contrary, if the field display rate is high, the number of sustain pulse is decreased and the sustain period 73 is reduced to decrease power consumption.

### <Drive Sequence (2-2)>

A structure (second constructional example) of a drive sequence in the second embodiment will be described with reference to FIGS. 6A and 6B. In the second constructional example, on the contrary to the first constructional example, the vacant time generated by APC and the like is arranged at the beginning of the first half and second half fields (F-A, F-B) respectively as the SF structure (SF′) of the second field structure (F′), as shown in FIGS. 6A and 6B.

As another constructional example, a structure in which the vacant time at the end of the first half field (F-A) is eliminated and the second half field (F-B) follows immediately after the first half field (F-A) in the first constructional example (structure of providing the vacant time only in the end of said field and the end of the second half field (F-B) thereof) can be employed. Furthermore, a structure in which the vacant time at the beginning of the second half field (F-B) is eliminated and the second half field (F-B) follows immediately after the first half field (F-A) in the second constructional example (structure of providing the vacant time only in the beginning of said field and the beginning of the first half field (F-A) thereof) can be employed.

### Third Embodiment

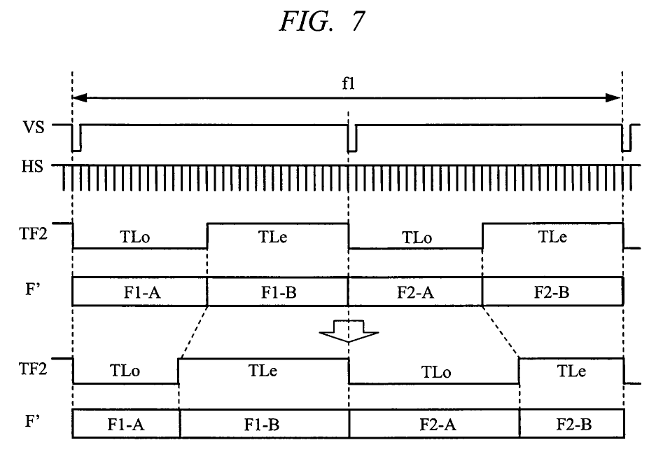

Next, a PDP device of a third embodiment of the present invention will be described with reference to FIG. 7. In the third embodiment, a basic structure is similar to that of the first embodiment and the like, and further has a structure in which an assignment of time length of the first half and the second half fields (F-A, F-B) is changed for each field, in the second field structure (F′) with respect to the first field structure (F).

In FIG. 7, display timing of the Field (F) and the display line group are discriminated by VS and HS with respect to the image frame (f). The second field structure (F′) in the second control is discriminated by TF2. For example, F1-A and F1-B with respect to the first field (F1), which is the odd numbered field (Fo), and F2-A and F2-B with respect to the second field (F2), which is the even numbered field (Fe), are constructed. According to the control in the third embodiment, the present example employs a structure in which the first half field (F1-A) becomes slightly shorter and the second half field (F1-B) becomes slightly longer in the first field (F1) at first. Subsequently, in the second field (F2), on the contrary to the first field (F1), a structure in which the first half field (F1-A) becomes slightly longer and the second half field (F1-B) becomes slightly shorter is employed. As described above, timing of the first half and the second half are changed by TF2 in each field (F). A boundary between the first half and the second half in the field is, for example, set to a position close to a center of the field, and is changed gradually around the center. And, for example, a structure in which timing of the boundary of the first half and the second half (for example, timing shown in F1-A, F1-B) is not changed and fixed in the continuous field group can be employed.

### Fourth Embodiment

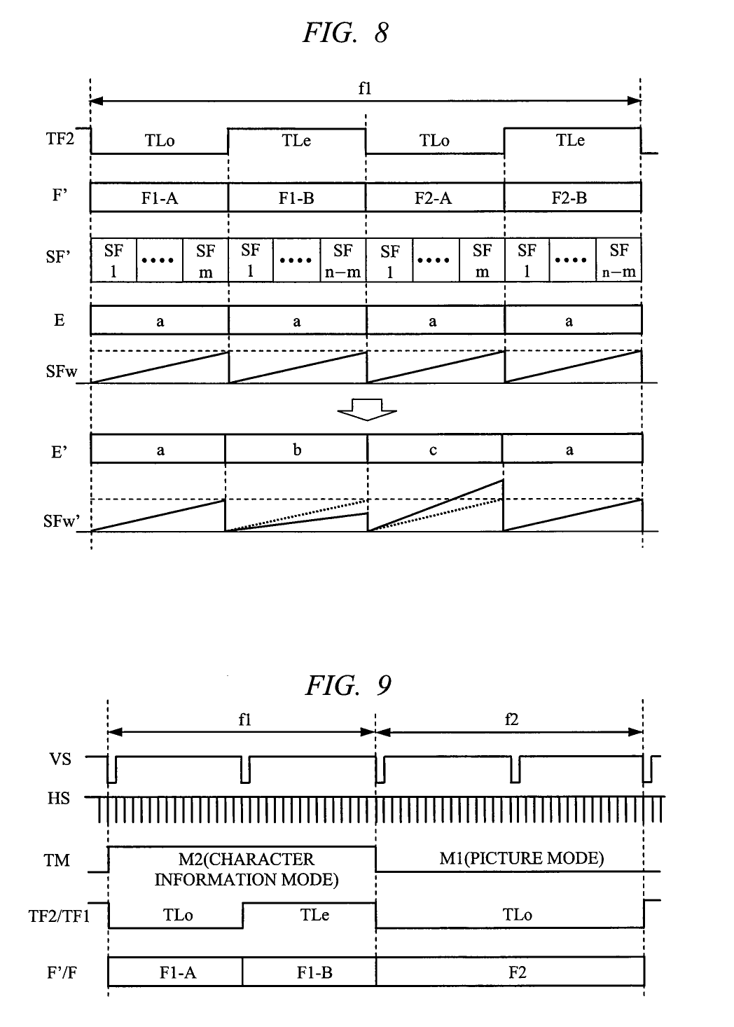

Next, a PDP device of a fourth embodiment of the present invention will be described with reference to FIG. 8. In the fourth embodiment, a basic structure is similar to that of the first embodiment and the like, and further has a structure in which structures of weighing of luminance of the SF group of the first half and the second half field (F-A, F-B) are not set to be the same but are changed for each period of first half field and second half field unit in the second field structure (F′) with respect to the first field structure (F).

In FIG. 8, with respect to the image frame (f), two fields (Fo, Fe), the first half and the second half fields (F-A, F-B), and the SF structure (SF′) similar to that described above, E (control coefficient) shows a control coefficient of weighing of luminance of the SF group in the second field structure (F′), and SFw (weight) shows an example of weighing (luminance ratio) of luminance of the SF group in the second field configuration (F′) schematically. First, in the embodiment described above, for example, SF1 to SFm of the first half field (F-A) and SF1 to SFn-m of the second half field (F-B) respectively have a structure in which E=a and SFw is fixed. That is, in SFw, for example, SF1 is the minimum weight, the weight is increased as the SF order rises, and the maximum weight is obtained at SFm and SFn-m. In the present example, E=a is a value (for example, a=1) to be multiplied with respect to a structure of basic SFw, however, it can be considered as a value representing an average luminance and the like in the second field structure (F′).

And, according to the control of the fourth embodiment, E is changed for each period of the first half and the second half field (F-A, F-B) like E′, in the display of the image frame (f) of the same image. For example, a value such as b<a<c is used as E′ and a structure of SFw′ is obtained. And, by setting as b×c=1, the luminance of the image frame (f) unit can be fixed. Thus, in the control of the fourth embodiment, a plurality of SF structures can be combined and used with making the display viewed by user to be the same (fixed) in displaying the same image.

### Fifth Embodiment

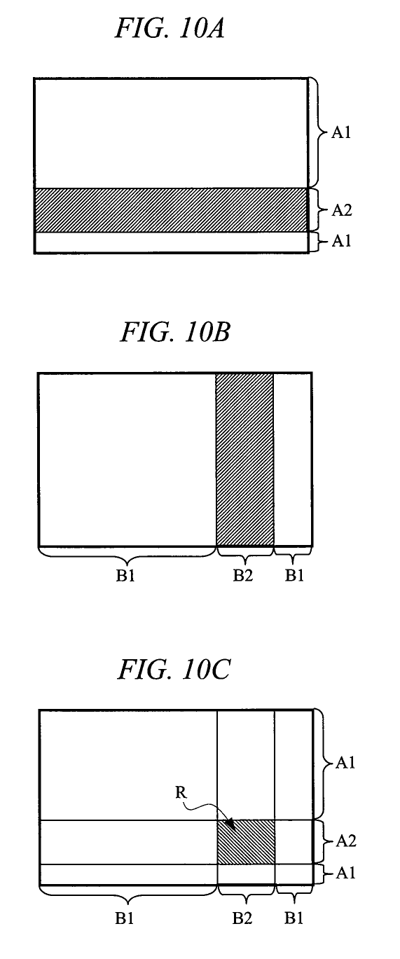

A PDP device of a fifth embodiment of the present invention will be described with reference to FIGS. 9 and 10A to 10C. In the fifth embodiment, a basic structure is similar to that of the first embodiment and the like, and further has a structure in which picture and character information in the field display are distinguished to select or limit a control (the first control, the second control) to be applied to a period or a region.

### <Character Information Determining Section>

In FIG. 1, in relation to the fifth embodiment, the PDP device includes a character information determining section 120. The character information determining section 120 may be included in the control circuit 110. The character information determining section 120 includes a character display portion discriminating section 121, a character display portion decision section 122, and a picture/character information discriminating section 123. Display data VIN and the like are inputted into the character display portion discriminating section 121, and the character display portion discriminating section 121 discriminates a region for displaying character information (character display portion) in an image/picture frame (field display) on the basis of the input. The character display portion is a region where characters such as captions are constantly displayed. And, similarly, the display data VIN and the like are inputted into the picture/character information discriminating section 123, and the picture/character information discriminating section 123 discriminates whether the current display is in a state of displaying picture (picture mode: M1) or a state of displaying character information (character information mode: M2) in the image/picture frame (field display) on the basis of the input. The discrimination result from the character display portion discriminating section 121 and the picture/character information discriminating section 123 are inputted into the character display portion decision section 122 of the character information determining section 120, and the character display portion decision section 122 determines a region for displaying the character (and region for displaying the picture, conversely), the period thereof and the like in the image/picture frame, and outputs a region determining signal, a mode (period) determining signal and the like to the identification circuit section 113. The identification circuit section 113 identifies the region and the period of display of the picture and the character information in the field corresponding to the image frame by the determining signals.

### <(1) Mode Determination>

In FIG. 9, an example of a drive sequence in a first constructional example (a case of mode determination) in the fifth embodiment is shown. This is a case in which a mode is divided for each image frame (f). Timing of the character information mode (M2) or the picture mode (M1) is discriminated by the mode determination signal (TM) with respect to the image frame (f) group. The second field structure (F′) in the second control or the first field structure (F) in the first control is discriminated by the TF2/TF1 according to TM. In the present example, a case of performing a control in which the second control is applied (second field structure (F′)) when TM is M2 (character information mode), and the first control is applied when TM is M1 (picture mode) is shown. In particular, since line flicker is likely to be occurred generally in the character information mode (M2), an effective countermeasure against the flicker can be obtained by applying the second control.

### <(2) Region Determination>

In FIGS. 10A to 10C, an example of a region in a screen of the PDP 10 in the second constructional example (a case of region determination) according to the fifth embodiment is shown. This is a case of dividing a region in the screen. In the second constructional example, a partial region is discriminated in the display of the field group with respect to the image frame (f) as described above, and a control (the first control, the second control) to be applied is changed according to a type (picture display portion, character display portion) of the region.

In FIG. 10A, A1 is a region of a normal display line (row or horizontal line) group, and A2 is a region of a specified display line group in the screen (field or the like). And, the first control is applied to the A1 region and the second control is applied to the A2 region. That is, in a region of the first control, the odd numbered and even numbered display line groups are driven with different display data, and in a region of the second control, the odd numbered and even numbered display line groups are driven with the same display data as described above. Note that, in the specification of the region, the information may be contained in an input signal, or may be newly specified in the present PDP device. In FIG. 10B, B1 is a region of a normal display line (column or vertical line) group, and B2 is a region of a specified display line group in the screen. And, similarly, the first control is applied to the B1 region and the second control is applied only to the B2 region. And FIG. 10C shows a mode of control obtained by combining FIG. 10A and FIG. 10B, in which R is a region obtained by AND operation of regions (A2, B2) of the specified display line region in the screen, and the second control is applied. To regions other than R, the first control is applied. That is, the second control is applied only to the specified region (R) in the screen.

### <Effects>

As described above, according to the second control in the first embodiment and the structure of each embodiment, by drive-displaying both odd numbered and even numbered display line groups as the second field structure (F′), occurrence of flicker in the screen, in particular, including line flicker can be prevented and suppressed in the display of the image frame group. And, since both odd numbered and even numbered display lines are continuously driven with the same data in the field according to the present structure, a margin is given to the processing speed, for example, in the control circuit 110. In the control circuit of the conventional PDP device, a double speed drive with respect to basic display frequency (for example, 60 Hz) is considered to prevent flicker in control and process of the field drive as in the first conventional art. In this case, the speed (frequency) of the clock used to store the display data in the frame memory must be increased more than in normal, and this is disadvantageous. On the other hand, in the present control circuit 110, the double speed drive and the like are not required, and the input/output control of the display data with respect to the frame memory 112 and the like can be realized without increasing the processing speed (clock speed) more than that in the conventional art.

Note that, difference from the conventional art is that both odd numbered and even numbered display lines are alternately displayed in the odd numbered or even numbered fields in the present device. Furthermore, in the present device, display of the interlace method is basically performed, and conversion to display of non-interlace method is not performed. Moreover, in the present device, special processing based on the display data of the horizontal line at the upper and lower ends of the screen is not performed. And, the present device is not provided to prevent flicker occurred at the upper and lower ends of the screen, but to prevent flicker of the entire screen including line units.

Hereinabove, the present invention made by the inventors has been explained specifically based on the embodiments thereof. However, the invention is not restricted to those embodiments. It is obvious that various changes and modifications may be made in a scope of the invention without departing from a gist of the invention.

The present invention is available in a PDP device and the like.

What is claimed is:

1. A plasma display panel driving method of performing display drive control including specification of display data to be used in a display line group to be a subject of drive-displaying with respect to a plasma display panel in which a display region including odd numbered and even numbered display line groups is constructed by a matrix of display cells of an electrode group,
wherein a field associated with the display region and a period is constructed in a structure temporally divided into a plurality of sub-fields for gray-scale expression, and
wherein based on a structure of the field time-dividing an image frame to be displayed by the odd numbered and even numbered display line groups of the display region, for at least one set of adjacent odd numbered and even numbered display lines in the display line group of the display region, both odd numbered and even numbered display lines of the set are drive-displayed continuously in a time division manner using display data of only one of the odd numbered and the even numbered display lines of the set in the field.

2. A plasma display device comprising:
a plasma display panel including a substrate over which a plurality of first and second electrodes to be used in sustain discharge is alternately arranged in a second direction with a structure extending parallel to a first direction, a plurality of third electrodes to be used in address discharge is arranged with a structure extending parallel to the second direction, an odd numbered display line is composed of a pair of the first and the second electrodes adjacent on one side in the second direction, an even numbered display line is composed of a pair adjacent on the other side, and a display cell is constructed at an intersection of the display lines and the third electrode; and
a circuit section including a control circuit performing display drive control including specification of display data to be used in a display line group to be a subject of drive-displaying and drive circuits for applying voltage for driving to the first, the second, and the third electrode groups respectively,
wherein a field associated with a display region and a period of the panel is constructed in a structure temporally divided into a plurality of sub-fields each having an address period and a sustain period for gray-scale expression, and
wherein based on a structure of a field time-dividing an image frame to be displayed by the odd numbered and even numbered display line groups of the display region, for at least one set of adjacent odd numbered and even numbered display lines in the display line group of the display region, the circuit section drive-displays both odd numbered and even numbered display lines of the set continuously in a time division manner using display data of only one of the odd numbered and the even numbered display lines of the set in the field.

3. The plasma display device according to claim 2,
wherein, in drive-displaying of the set of display lines, the field is divided into a first half field and a second half field to have about half a length of the field respectively by division in the sub-field unit, one of the display lines is drive-displayed using display data of one of the display line in the first half field, and the other display line is drive-displayed using the display data of one of the display line which is same as that for the first half field in the second half field.

4. The plasma display device according to claim 3,
wherein, in drive-displaying of two consecutive fields, drive-displaying is performed using display data of the odd numbered display line in the drive-displaying of the set of display lines in the first field, and drive-displaying is performed using the display data of the odd numbered display line which is same as that used for the field one before in the drive-displaying of the set of display lines in the following second field.

5. The plasma display device according to claim 2,
wherein the field has a fixed period and when vacant time of driving is generated in the field according to a time length of the sub-field, the vacant time is arranged at end or beginning of a period of driving respective display lines of the set of display lines in the field.

6. The plasma display device according to claim 2,
wherein the field has a fixed period and when vacant time of driving is generated in the field according to a time length of the sub-field, the vacant time is collectively arranged at end or beginning of the field.

7. The plasma display device according to claim 2,
wherein timing of switching displaying period of the odd numbered and even numbered display lines of the set of display lines in the field is changed for each field.

8. The plasma display device according to claim 2,
wherein, when displaying same image, for each period of driving each display line of the set of display lines in the field, a weighing structure of luminance of sub-field group of the period is changed.

9. The plasma display device according to claim 2,
wherein determination whether picture or character information is handled in a period to be a subject of drive-displaying is made based on input or output display data, and an operation of continuously drive-displaying the set of display lines is applied with respect to a period handling the character information.

10. The plasma display device according to claim 2,
wherein an operation of continuously drive-displaying the set of display lines is applied with respect to only a specified region of a part of the display region.

11. The plasma display device according to claim 2,
wherein whether the odd numbered or the even numbered display data to use is selected by automatically discriminating which is more appropriate for each field.
